(19) United States
(12) Patent Application Publication
(10) Pub. No.: US 2004/0184954 A1
(43) Pub. Date: Sep. 23, 2004

(54) Lateral flow immunoassay devices for testing saliva and other liquid samples and methods of use of same

(76) Inventors: Huiyan Guo, San Diego, CA (US); Hsaioho Edward Tung, San Diego, CA (US); Eleanor M.S. McCarthy, San Diego, CA (US); Ying Yang, Hangzhou (CN); Yuchang Wu, Hangzhou (CN)

Correspondence Address: ACON LABRATORIES, INC., 4108 SORRENTO VALLEY BLVD., SAN DIEGO, CA, 92121, US

(21) Appl. No.: 10/717,082

(22) Filed: Nov. 19, 2003

Related U.S. Application Data
(60) Provisional application No. 60/455,669, filed on Mar. 18, 2003.

(51) Int. Cl. G01N 21/00

(52) U.S. Cl. 422/56; 422/58

(57) ABSTRACT

The present invention is a device for collecting and testing a liquid sample, for example a viscous sample, such as oral fluid or saliva. The present invention provides a simple and sanitary means of collecting a sample, testing a portion of the sample for one or more analytes of interest, and storing the remaining sample. The stored sample may be used at a later time for confirmation of the test results. In certain embodiments of the present invention, the reservoir of stored sample may be removed from the device prior to storage. The present invention is particularly useful of drug of abuse testing, as well as indicators of health and/or disease state.

### CROSS-REFERENCE TO A RELATED APPLICATION

This application claims priority of previously filed Unites States Provisional Patent Application Serial No. 60/455,669, filed Mar. 18, 2003. The disclosure of the provisional application is incorporated herein by reference.

### BACKGROUND OF THE INVENTION

1. Field of the Invention

The present invention relates generally to the fields of immunoassay test devices that can be used to test for the presence of an analyte.

2. Description of the Related Art

There are a variety of clinical lateral flow immunoassay devices useful for testing for the presence of an analyte in a sample, such as biological samples. In general, these test devices take the form of urine cups with accompanying test cards, dip sticks and cassettes. All of these devices require the use of a potentially infective biological fluid, such as urine, blood or serum that clinical workers find messy and offensive to work with and expose the worker to disease hazards. For example, urine cups are often urinated on the exterior and are easily spilt. Similarly, blood samples require the use of needles for collection, which can expose the clinical worker to a variety of blood-born diseases, such as AIDS and hepatitis. While the afore mentioned devices have been improving, there continues to be a long felt need for a device that is simple to use, not messy and poses little health risk to the clinical worker. This long felt need is met by the present invention, which is described in detail herein.

### SUMMARY

The present invention recognizes that it can be desirable to have improved immunoassay devices that are more easily used by the consumer, such as a body that includes a test strip. These improved devices relate to lateral flow immunoassays that can be used to test for the presence of an analyte in a liquid sample, such as a viscous liquid sample, including saliva. The present invention provides such a device and methods of use.

As a non-limiting introduction to the breadth of the present invention, there are disclosed several general and useful embodiments, including:

1. a test device that comprises a casing, an absorbent sample applicator, a sample application well, a sample divider, at least one test strip that is in fluid communication with said sample divider, and a sample reservoir in fluid communication with said sample divider;

2. a method of detecting an analyte in a sample, including providing a sample, contacting the sample with a test device of the present invention and detecting the analyte in the sample, if present; and

3. a test kit comprising at least one test device packaged together with instructions for use of said test device.

These embodiments of the invention, as well as others described herein, can be achieved by using the methods, articles of manufacture and compositions of matter described herein. To gain a full appreciation of the scope of the present invention, it will be further recognized that various embodiments of the present invention can be combined to make desirable embodiments of the invention.

### BRIEF DESCRIPTION OF THE DRAWINGS

FIG. 1 is a perspective view of the liquid sample collection, testing and storage device 100 of the present invention in an assembled state.

FIG. 2 is a top perspective view of the liquid sample collection, testing and storage device of FIG. 1 in an exploded state.

FIG. 3 is a bottom perspective view of the liquid sample collection, testing and storage device of FIG. 1 in an exploded state.

FIG. 4A is a top view of the top member 230 of the device of FIG. 1.

FIG. 4B is a perspective view of the top member of the device of FIG. 1.

FIG. 5 is views of six sides and a perspective view of the body 110 of the device of FIG. 1.

FIG. 6A is a front view of the absorbent applicator 120 of the device of FIG. 1.

FIG. 6B is a side view of the absorbent applicator 120 shown in FIG. 6A taken 90° from the view of FIG. 6A.

FIG. 6C is a top view of the absorbent applicator 120 shown in FIG. 6A.

FIG. 6D is a cross-sectional view of the absorbent applicator 120 shown in FIG. 6A.

FIG. 7 is a cross-sectional view of the assembled liquid sample collection, testing and storage device of FIG. 1, illustrating some of the steps of expressing a sample from the absorbent applicator 120. Step 1 shows the absorbent applicator placed in the sample application well 210. Step 2 shows the absorbent applicator 120 pressed down into the sample application well 210, and liquid sample 710 simultaneously flowing into the reservoir interior 320 and onto a test strip 700. Step 3 shows the absorbent applicator 120 pressed down and twisted, in the sample application well 210, to lock the absorbent applicator 120 into place.

FIG. 8 illustrates some of the steps of closing the reservoir 260 of the assembled liquid sample collection, testing and storage device shown in FIG. 1. Step 1 shows the reservoir 260 in the open position. The reservoir 260 is closed by rotating it. Step 2 shows the reservoir 260 in the closed position. The stored sample is accessed through the sealing means 234. Step 3 shows the reservoir 260 in the closed position and the sealing means 234 broken.

FIG. 9A is another perspective view of the device shown in FIG. 1, with the sample application well 210 removed.

FIG. 9B is a top view of the device of the present invention with the sample application well 210 removed.

FIG. 9C is a cross-section of the device illustrated in FIG. 9B.

FIG. 9D is an isometric view of the device shown in FIG. 1, illustrating how, in certain embodiments, the middle ring 214 may fit inside the orifice 224 of the lower ring 216.

FIG. 10A shows several views of one embodiment of the expression means 300 of the liquid sample collection, testing and storage device of the present invention shown in FIG. 1.

FIG. 10B shows several views of another embodiment of the expression means 300 of liquid sample collection, testing and storage device of the present invention shown in FIG. 1.

FIG. 11A shows several views and a cross-section of one embodiment of the reservoir 260 of liquid sample collection, testing and storage device of the present invention shown in FIG. 1.

FIG. 11B shows two perspective views of the reservoir cap 1106 of one embodiment of the reservoir 260 of liquid sample collection, testing and storage device of the present invention shown in FIG. 1.

FIG. 12 illustrates some of the steps to remove and close the reservoir 260 in one embodiment of liquid sample collection, testing and storage device of the present invention shown in FIG. 1. In Step 1, the reservoir 260 is rotated to the remove position. In step 2, the reservoir is manually pulled down off of the body 110 of the liquid sample collection, testing and storage device of the present invention shown in FIG. 1. Step 3 illustrates the reservoir separated from the body 110 of the present invention. Step 4 is another illustration of the removed reservoir 260. The removed reservoir 260 is closed by flipping up the reservoir cap 1106 (Step 5) and pressing the reservoir cap into the reservoir aperture 263 (Step 6). Step 7 shows the seal of the reservoir cap 1106 broken, so that the sample can be removed from the reservoir interior 320.

### DETAILED DESCRIPTION

Definitions

Unless defined otherwise, all technical and scientific terms used herein have the same meaning as commonly understood by one of ordinary skill in the art to which this invention belongs. Generally, the nomenclature used herein and the manufacture or laboratory procedures described below are well known and commonly employed in the art. Conventional methods are used for these procedures, such as those provided in the art and various general references. Terms of orientation such as “up” and “down” or “upper” or “lower” and the like refer to orientation of the parts during use of the device. Where a term is provided in the singular, the inventors also contemplate the plural of that term. The nomenclature used herein and the laboratory procedures described below are those well known and commonly employed in the art. As employed throughout the disclosure, the following terms, unless other wise indicated, shall be understood to have the following meanings:

“Assaying” denotes testing for or detecting the presence of a substance or material, such as, but not limited to, a chemical, an organic compound, an inorganic compound, a metabolic product, a drug or a drug metabolite, an organism or a metabolite of such an organism, a nucleic acid, a protein, or a combination thereof. Optionally, assaying denotes measuring the amount of the substance or material. Assaying further denotes an immunological test, a chemical test, an enzymatic test, and the like.

An “analysis device” or “assay device” or “test device” is a device for analyzing a sample or specimen. An analysis device can be used to detect the presence and/or concentration of an analyte in a sample or specimen, or to determine the presence and/or numbers of one or more components of a sample or specimen, or to make a qualitative assessment of a sample or specimen. Analysis devices of the present invention include but are not limited to cuvettes, slides, lateral flow detection devices such as assay strip devices, and columns.

A “lateral flow detection device” or a “lateral flow test device” is a device that determines the presence and/or amount of an analyte in a liquid sample or specimen as the liquid sample or specimen moves through a matrix or material by lateral flow or capillary action, such as an immunochromatographic device. A lateral flow detection device may be used in a vertical or a horizontal orientation or in an orientation between vertical and horizontal. Persons knowledgeable in the art commonly refer to a lateral flow detection device using terms such as “immunochromatographic,” “dip sticks,” “membrane technology” and “test strips.”

“Analyte” is the compound or composition to be measured that is capable of binding specifically to a ligand, receptor, or enzyme, usually and antibody or antigen such as a protein or drug, or a metabolite, the precise nature of antigenic and drug analytes together with numerous examples thereof are disclosed in U.S. Pat. No. 4,299,916 to Litman, et al., particularly columns 16 to 23, and in U.S. Pat. No. 4,275,149, columns 17 and 18, the disclosures of which are incorporated herein by reference. Analytes can include antibodies and receptors, including active fragments or fragments thereof. An analyte can include and analyte analogue, which is a derivative of an analyte, such as, for example, an analyte altered by chemical or biological methods, such as by the action of reactive chemicals, such as adulterants or enzymatic activity.

“Sample” or “specimen” may be used interchangeably. “Sample” or “specimen” denotes any material to be assayed for the presence and/or concentration of an analyte in a sample or specimen, or to determine the presence and/or numbers of one or more components of a sample or specimen, or to make a qualitative assessment of a sample or specimen. A sample can be the same as a specimen. Preferably, a sample is a fluid sample, preferably a liquid sample. Examples of liquid samples that may be assayed using a assay device of the present invention include bodily fluids including blood, serum, plasma, saliva, urine, ocular fluid, semen, and spinal fluid; water samples, such as samples of water from oceans, seas, lakes, rivers, and the like, or samples from home, municipal, or industrial water sources, runoff water or sewage samples; and food samples, such as milk or wine. Viscous liquid, semi-solid, or solid specimens may be used to create liquid solutions, eluates, suspensions, or extracts that can be samples. For example, throat or genital swabs may be suspended in a liquid solution to make a sample. Samples can include a combination of liquids, solids, gasses, or any combination thereof, as, for example a suspension of cells in a buffer or solution. Samples can comprise biological materials, such as cells, microbes, organelles, and biochemical complexes. Liquid samples can be made from solid, semisolid or highly viscous materials, such as soils, fecal matter, tissues, organs, biological fluids or other samples that are not fluid in nature. For example, these solid or semi-solid samples can be mixed with an appropriate solution, such as a buffer, such as a diluent or extraction buffer. The sample can be macerated, frozen and thawed, or otherwise extracted to form a fluid sample. Residual particulates can be removed or reduced using conventional methods, such as filtration or centrifugation.

“Subject” refers to any organism, such as an animal or a human. An animal can include any animal, such as a companion animal such as a dog or cat, an agricultural animal such as a pig or a cow, or a pleasure animal such as a horse.

“Test strip” refers to an article of manufacture or composition that includes one or more zones, such as, for example, one or more of the following in any appropriate configurations: sample application zone, reagent zone, detection zone and control zone. A test strip can be used to detect the presence or absence of an analyte, such as a chemical, antigen or antibody. Test strips are known in the art, particularly immunochromatographic and “dip” type test strips that are used to detect, for example, reproductive hormones, drugs of abuse, etiological agents or chemicals in samples, such as but not limited to blood or urine.

“Zone” such as a zone on a test strip refers to a locus on a test strip. A zone preferably includes a reagent, such as a chemical, antibody or antigen that is directly, indirectly, reversibly or irreversibly immobilized at such locus.

Other technical terms used herein have their ordinary meaning in the art that they are used, as exemplified by a variety of technical dictionaries.

Lateral Flow Immunoassay Device for Testing Saliva and Other Liquid Samples

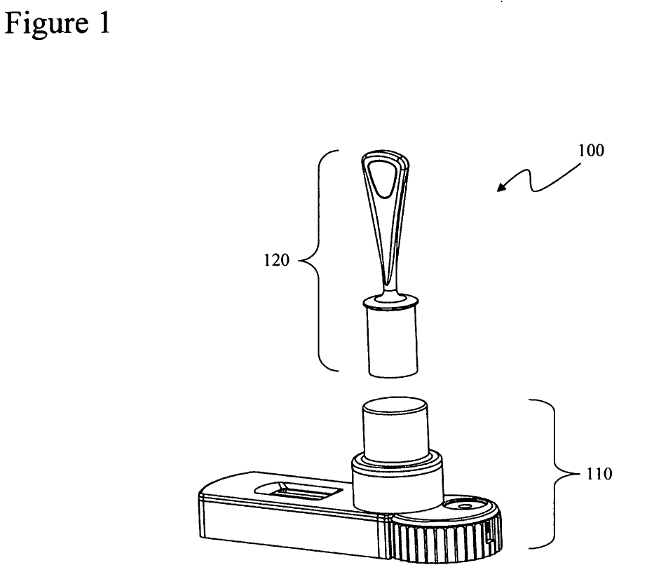

Turning now to the figures, FIGS. 1 through 4 illustrate one embodiment of the lateral flow immunoassay device of the present invention 100. The device comprises an absorbent sample applicator 120, for collecting a sample or specimen, from a subject in need of testing for an analyte in the subject's bodily fluid, and a body 110 or casing. The body 110 further comprises a sample application well 210, a sample expression means 300, a sample divider 310, for dividing the sample into two portions, and a reservoir 260. The sample application well 210 is in fluid communication with the sample expression means 300. The sample expression means 300 is in fluid communication with the sample divider 310 that directs sample into two or more separate compartments, such as to the reservoir 260 and to the test strip. The sample divider 310 is in fluid communication with the reservoir 260. One portion of the sample 710 flows into the reservoir interior 320 and is stored, and optionally used for confirmation testing of the presence of the analyte of interest in the collected sample.

FIGS. 1, 2, 6 and 7 illustrate the sample applicator 120. The sample applicator 120 further comprises an absorbent member 255 and a handle 250. The absorbent member 255 is generally made of medical grade sponge or foam material commonly used in the art; however, many other materials are available for use as an absorbent member 255, such as cotton or paper. The handle 250 is generally rigid, to facilitate manipulation of the absorbent member 255. The handle 250 may be made of any material commonly employed in the art, such as plastic, wood, metal or cardboard. The handle further comprises a handle attachment means 252 for attaching the absorbent member 255 to the handle 250 and a locking flange 600. The absorbent member 255 may be attached to the handle attachment means 253 by a variety of methods commonly used in the art. These means of attachment of the absorbent member 255 to the handle attachment means 252 include, but are not limited to, gluing, melting and cooling, clipping or pinching, and the like. The absorbent member 255 is preferably attached to the handle attachment means 252 with suitable medical grade hot glue, similar to the kind of glue used in hot glue guns found in hardware and craft stores. For example, a small quantity of the medical grade hot glue is applied the bottom surface 254 of the handle attachment means 252. Then the absorbent member 255 is pressed on to the hot glue for several seconds. When the hot glue cools, the absorbent member 255 is attached to the bottom surface 254 of the handle attachment means 252. In some embodiments of the present invention, the handle 250 further comprises a finger grip 251, which optionally may be textured, to facilitate holding the sample applicator.

In certain embodiments, the present invention further comprises a cap 200 for sealing the sample application well 210. The cap 200 can be used, for example, to keep the device interior clean prior to use. In another example, the cap 200 can be used to close the device after use and prior to shipping to a confirmation laboratory facility.

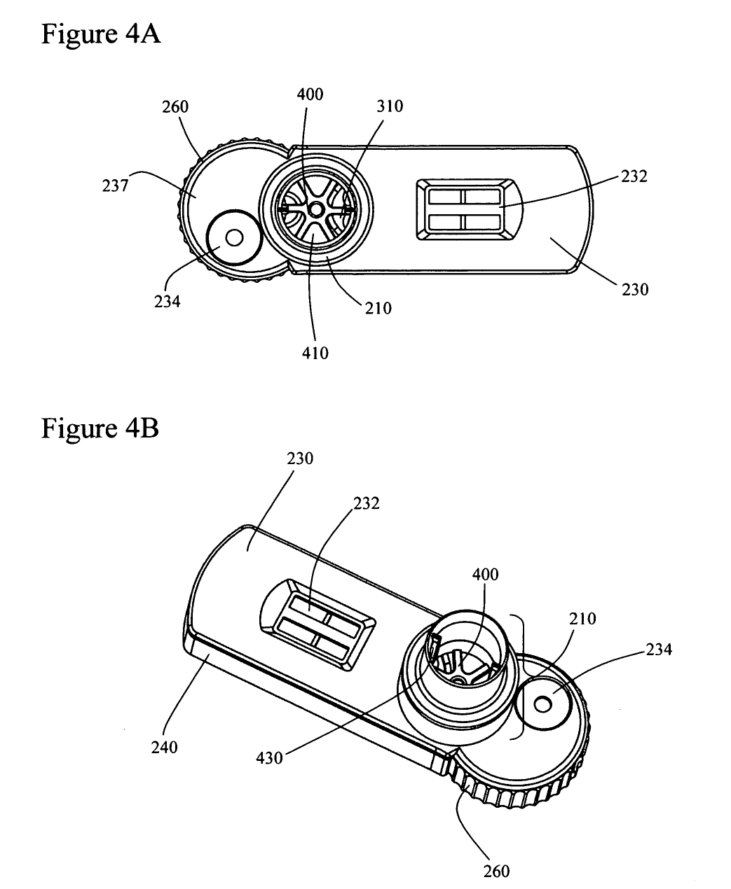

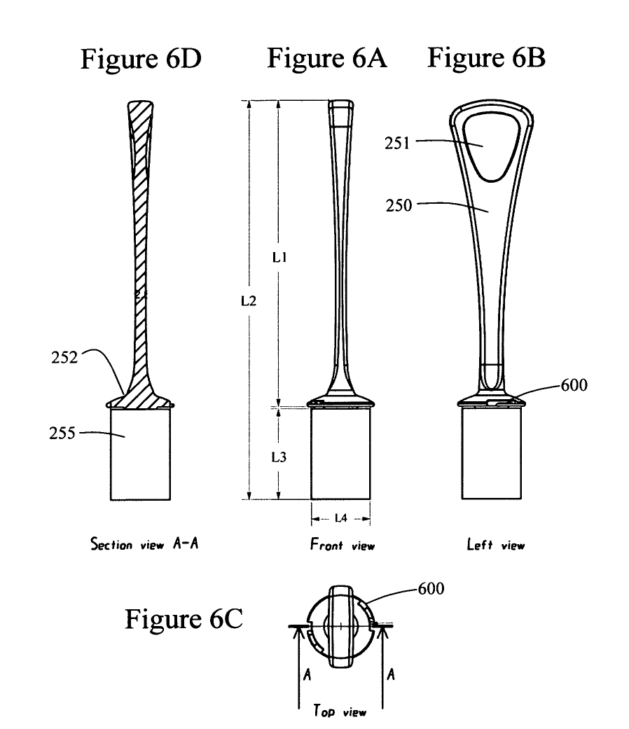

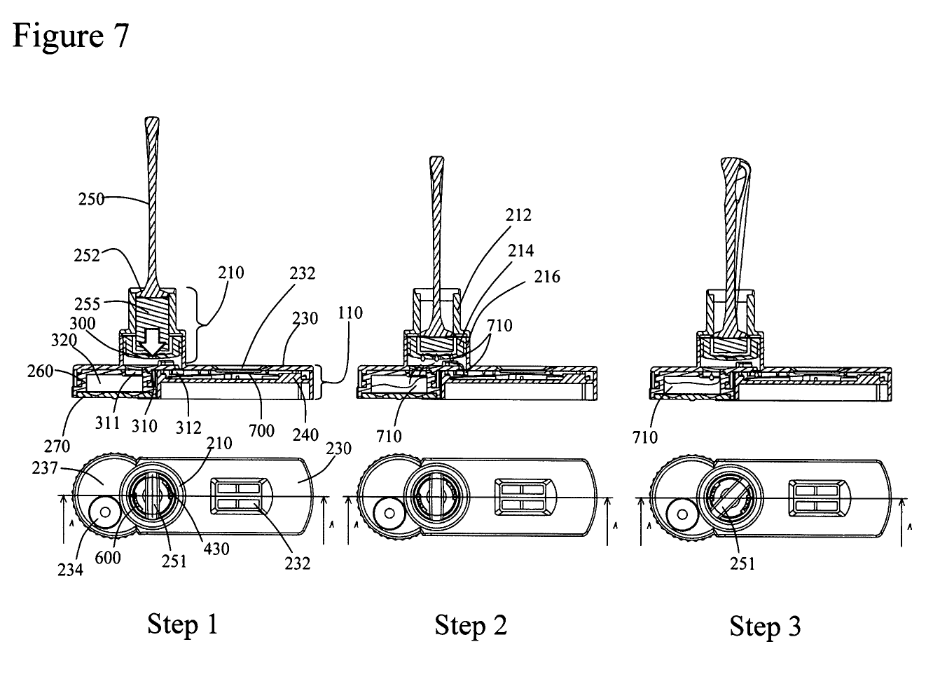

In additional embodiments of the present invention, the handle 250 further comprises a flange 600. As shown in FIG. 6, the flange 600 engages ribs 430 (see FIG. 4) within the orifice 220 of the upper ring 212 of the sample application well 210, to lock the absorbent applicator 120 into place. The applicator can be pressed down against the expression means 300, in order for the flange 600 to lock into place under the ribs 430 (see FIG. 7, steps 1-3). Locking the absorbent applicator 120 into place ensures that the absorbent member 255 is sufficiently compressed and that a sufficient quantity of the collected specimen 710 will be expressed from the absorbent member 255. The reservoir interior 360 is in fluid communication with the sample divider 310 via a first sample divider aperture 311.

In further embodiments of the present invention, the body 110 comprises at least one test strip 700 (shown in FIG. 7) encased within the casing 110 and in fluid communication with the sample divider 310 via a second sample divider aperture 312. The test strip 700 enables diagnostic testing or analysis of a portion of the sample 710. As will be discussed in greater detail, a portion of the sample 710, expressed from the absorbent member 255 by the expression means, flows through the second sample divider aperture 312 and then onto the test strip 700. A portion of the sample that flows onto the test strip 700 from the sample divider 310 is absorbed by the test strip 700. The portion of sample absorbed by the test strip 700 is assayed for the presence of one or more analytes of interest.

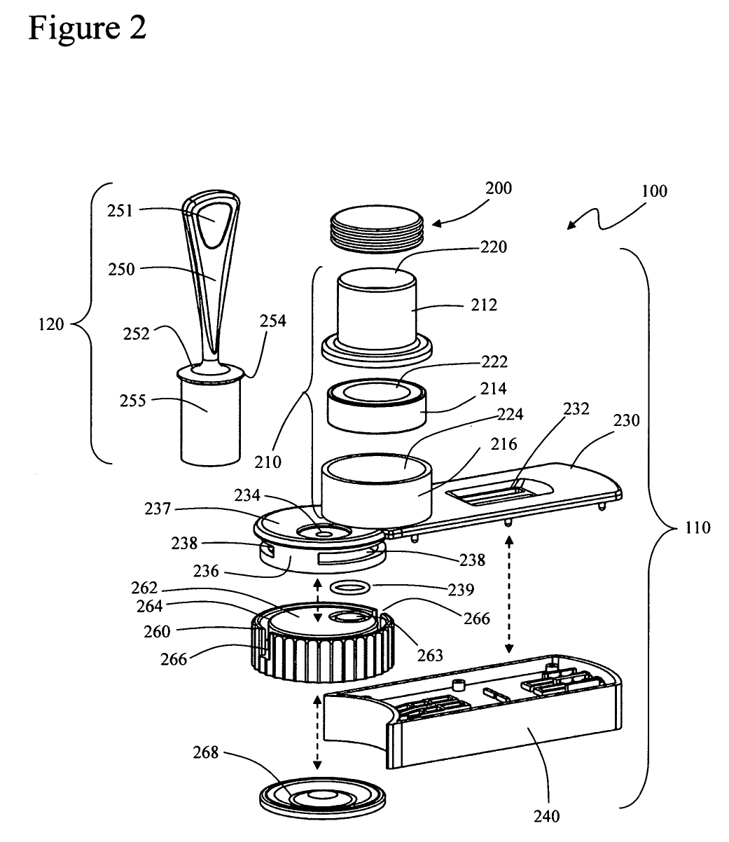

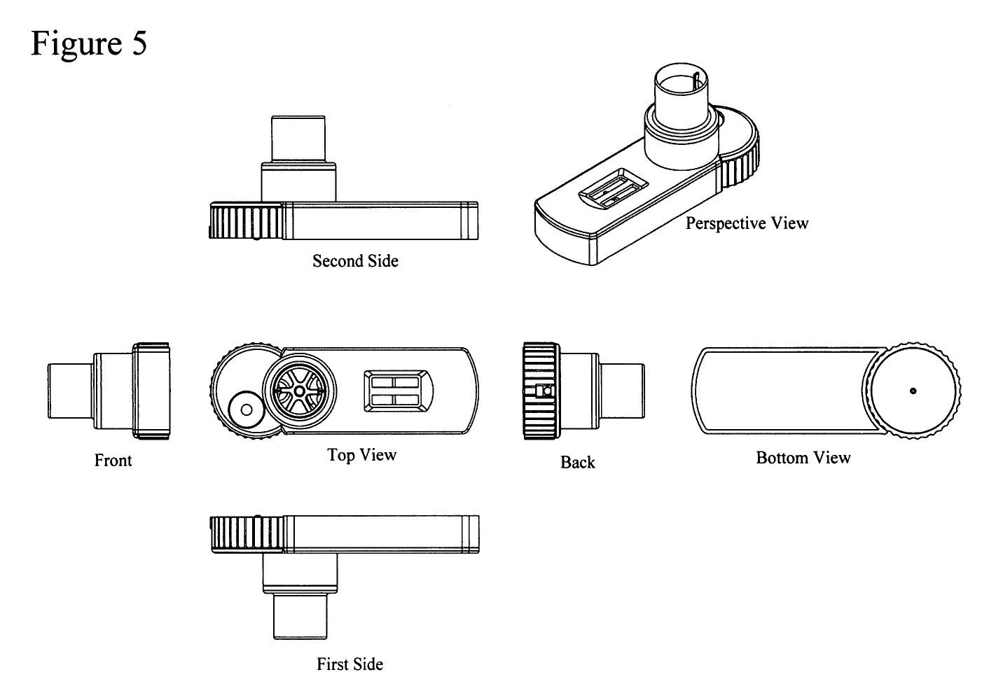

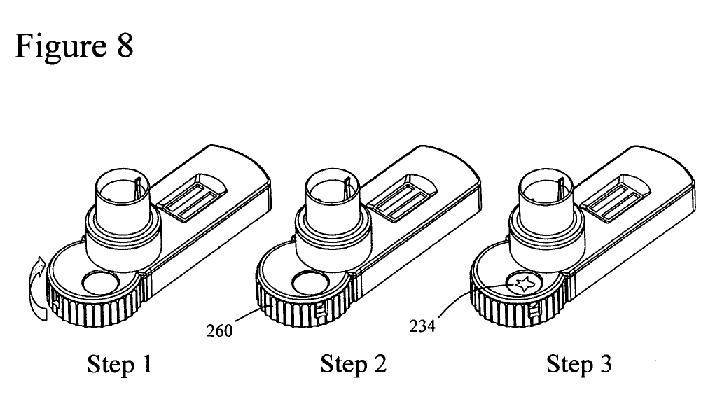

As show in FIGS. 2-9, the body 110 of the present invention 100 further comprises a top member 230, having an outside surface and an inside surface. In further embodiments of the present invention, the top member 230 further comprises a reservoir attachment area 237 and a reservoir attachment means 236. The reservoir attachment means 236, optionally had a reservoir rotation groove 238, for facilitating and guiding rotation of the reservoir 260 about the reservoir attachment means 236.

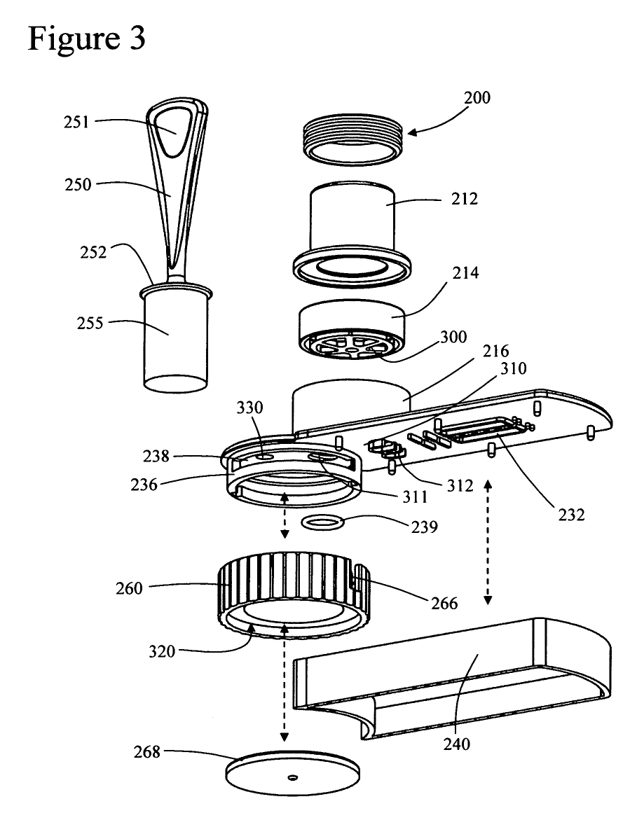

In additional embodiments of the present invention, the reservoir attachment area 237 further comprises a sealing means 234 and an aperture 311 (see FIG. 3). The sealing means 234 covers the aperture 311 in the reservoir attachment area 237. The aperture 311 in the reservoir attachment area 237 is in alignment with the reservoir aperture 263 when the reservoir 260 has been turned from the open position to the closed position. The sealing means 234 can be made of any liquid impervious material commonly used in the art. For example, the sealing means 234 may be selected from the group consisting of foil, plastic, plastic coated foil, wax, and tape. In certain embodiments the sealing means 234 is breakable, puncturable or removable, so as to facilitate removal of an aliquot of the portion of sample contained in the reservoir through the aperture 311.

As illustrated in FIGS. 1-5, the top member 230 further comprises a sample application well 210 sized to receive the sample applicator 120. The sample application well 210 may have the appearance of a miniature chimney. But other shapes and sizes of sample application wells 210 are contemplated by the present invention. In certain embodiments of the present invention, the sample application well 210 is attached to the outer surface of the top member 230, substantially adjacent to and slightly over the reservoir attachment means 236. In further embodiments of the present invention, the sample application well 210 is placed on the outer surface of the top member 230 in such a position that a first aperture 311 of the sample divider 310 within the sample application well 210 is in alignment with the reservoir aperture 263. The sample application well 210 may be comprised of one or more rings. For example, the sample application well 210 illustrated in FIGS. 1-4, is comprised of three rings, an upper ring 212, a middle ring 214 and a bottom ring 216. Each ring of the sample application well 210 defines an orifice, the upper ring orifice 160, the middle ring orifice 222 and the bottom ring orifice 224. The sample application well 210 can be of any geometric shape or dimension such as, but not limited to, triangular, spherical, oval, square, rectangular, pentagonal, hexagonal, heptagonal, octagonal, or any polygon, or non-geometric shape such as kidney or bean shaped, but is preferably substantially cylindrical. The size of the sample application well 210, encompassing such dimensions as the width, height and diameter of the sample application well 210 can readily accept insertion of the absorbent member 255 or can be such that an indiscriminate or predetermined volume of a sample can be dispensed into the well. The proximal or receiving end of the sample application well 210 can be flared, funnel shaped or otherwise molded such that the absorbent member 255 or a sample can readily and accurately be transferred into the sample application well 210, but this need not be the case. Alternatively a funnel shaped adaptor can be separable and directly or indirectly engage the proximal end of the sample application well 210.

In one embodiment of the present invention one or more longitudinal ribs 430, ridges or edges, or a concentric spiral ridge can be arranged along the interior of the sample application well, FIG. 4B. The one or more structures can facilitate extraction of the sample 710 from the absorbent member 255.

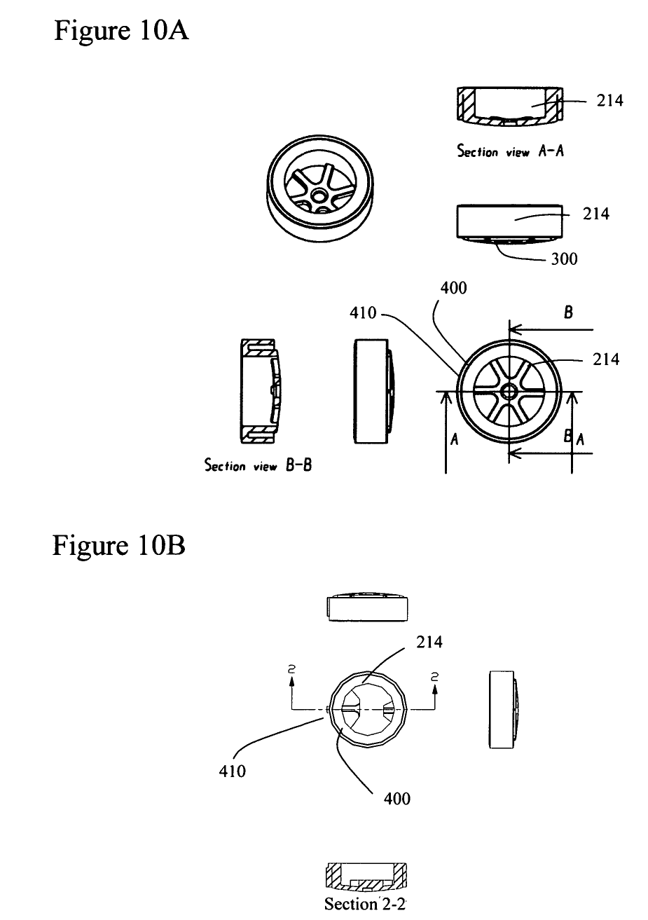

In a further embodiment of the present invention, the middle ring 214 fits snuggly inside the bottom ring 216, as shown in FIG. 7. The middle ring 214 further comprises an expression means 300 that can engage the absorbent member 255 to express sample therefrom. In this regard, the expression means 300 generally takes the form of a flat disk with radially-extending arms 400 that form one or more openings 410. As illustrated in FIGS. 4-5 and FIG. 10A, in certain embodiment of the present invention, the expression means 300 may look like a wagon wheel, having plurality of spokes 400 and expression means apertures 410 there between. In this embodiment of the present invention, the absorbent member 255 is pressed into the middle ring 214 and against the expression means 300. This causes a portion of the sample 710 contained in the absorbent member 255 of the applicator 120 to be expressed from the absorbent member 255. The expressed sample passes between the spokes 400 of the expression means 300, through the expression means apertures 410, to the sample divider 310. FIG. 10B illustrates and alternative embodiment of the expression means 300, in which the spokes 400 are wide and flat, with fewer expression means spaces 410. Additional conformations of expression means 300 are contemplated by the present invention.

Other arrangements of rings or pieces of the sample application well 210 are contemplated by the present invention. For example, the rings may be arranged and sized to be telescopingly movable. In this alternative embodiment, the device could be shipped with the sample application well 210 collapsed, to save space and reduce cost. The technician would telescopingly open the sample application well, to prepare the device for use.

FIG. 7 generally illustrates how a technician would transfer the collected sample to the body 110 of the test device. As illustrated in step 1, in certain embodiments of the present invention, the upper ring 212 guides the sample applicator 120 down into the application well 210. As discussed supra, the upper ring 212 may optionally contain one or more ribs 430. The ribs 430 can help to guide the sample applicator into the application well 210. FIG. 7, steps 1-2 shows that the absorbent member 255 of the sample applicator 120 is inserted into the upper ring orifice 220.

Next, the technician presses the absorbent member 255 down into the middle ring orifice 222, using the handle 250 (see FIG. 7, step 2). The middle ring orifice 222 is fitted with the expression means 300. (Refer to FIG. 10 for more detailed drawings of the expression means 300.) When the absorbent member 255 is pressed against the expression means 300, a portion of the collected sample 710 is expressed from the absorbent member 255. The expressed sample 710 flows through at least one space 410 of the expression means 300. FIG. 7, step 3 illustrates that when the absorbent member 255 is substantially pressed down into the middle ring 214, the user can optionally lock the sample applicator 120 into the application well 210 by rotating the applicator handle 250. FIG. 7 illustrates the handle 250 rotated in a clockwise direction. However, the flange 600 can be designed for counter-clockwise rotation. When the handle 250 is fully pushed down into the sample application well 210 and rotated in the appropriate direction, the flange 600 will engage the ribs 430 within the upper ring orifice 220 (see FIG. 4B), thereby locking the applicator into the pushed-down position shown in FIG. 7, step 3. Locking the applicator 120 into the application well 210 ensures that the applicator is sufficiently pressed into the middle ring 214. However, it is not necessary to lock the applicator 120 into the application well 210.

In one embodiment of the test device of the present invention the sample application well 210 can be removably mounted on the top member 230 of the body 110. The distal end of the sample application well 210 can removably engage the top member 230, preferably at an opening or aperture of the top member 230, such that they are substantially perpendicular to each other. The sample application well can be inserted into an aperture of the top member 230 in order to engage the top member 230. Insertion can be by various structures such as, but not limited to, slide, push, snap, twist, bayonet fit, or screw the distal end of the sample application well into an aperture of the body 110. For example, the aperture can have a spiral path along the inner wall and threads can be formed along the external distal region of the sample application well such that they can be attached by a twisting or screwing motion. In the case of a snap insertion a groove can be formed along the inside wall of the aperture and a raised ridge can encircle the outside distal region the sample application well 210 such that the sample application well 210 can be slid into the aperture and the ridge snaps or locks into the groove of the aperture. Alternatively, the aperture can be encircled by a raised edge, with or without grooves or threads, over which the sample application well 210 can be slid, snapped or screwed to engage the top member 230. Grooves or threads can be machined into the appropriate component during manufacture using techniques commonly used in the art. A snap or snug fit can confer a reassuring sound or feel so that the operator is confident the sample application well 210 and the top member 230 have engaged properly. Optionally, a structure such as a gasket or O-ring can be positioned at the intersection of the sample application well 210 and the top member 230 to prevent leakage.

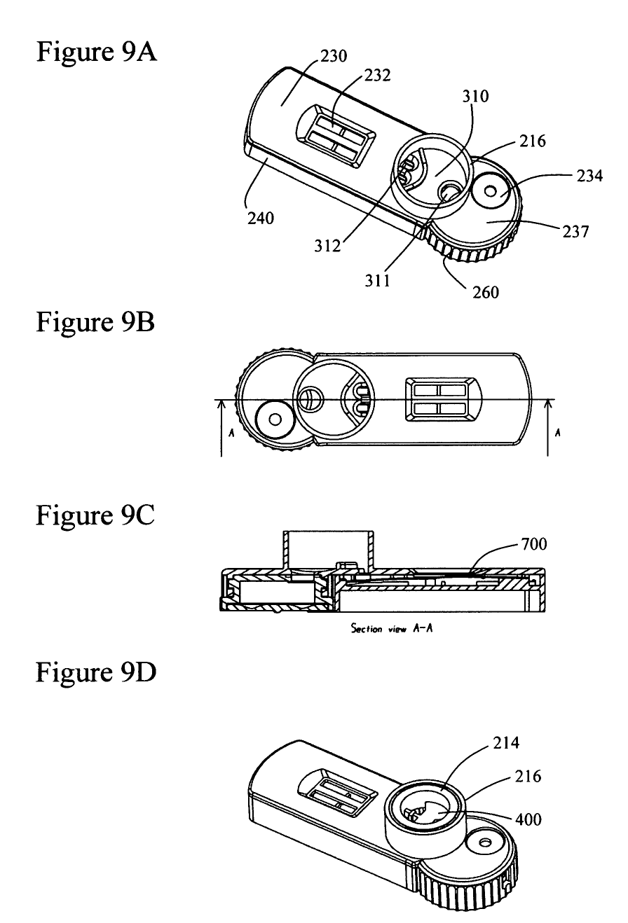

As illustrated in FIG. 7 and FIG. 9, in certain embodiments of the present invention, the bottom ring 216 of the sample application well 210 further comprises a sample divider 310 that can form two or more fluid pathways that guide separate portions of the sample 710 into separate locations. The sample divider 310 is in fluid communication with the reservoir 260 via first aperture 311 and a test strip 700 via second aperture 312. In one embodiment, the sample divider 310 is adjacent the expression means so that when the expression means engages the sample divider 310, the sample flows directly from the expression means through the divider and into the reservoir or onto the test strip. This is the opposite of other saliva test devices currently on the market, which require the sample to flow down a flow path, and to be sequentially divided and diverted into the test strip casing and a reservoir.

Step 2 of FIG. 7 shows that as the collected fluid sample 710 is expressed from the absorbent member 255, the expressed sample is divided into at least two portions. When the reservoir is in the open position, the reservoir aperture 263 is aligned with the first aperture 311 of the sample divider 310. A portion of the expressed sample 710 flows from the expression means 300, through the first aperture 311, through the reservoir aperture 263 and into the reservoir 260. Another portion of the expressed sample 710 flows from the expression means 300, through the second aperture 312, and onto a diagnostic test strip 700. While the figures illustrate two second apertures 312 in fluid communication with the test strip 700 and both capable of guiding sample flow onto the test strip 700, only one second aperture 312 is necessary. Additional first or second apertures may be optionally included, to adjust the flow characteristics of the sample 710, in order to control the sample 710 flow rate.

In additional embodiments of the present invention, the top member 230 of the test device further comprises an exterior surface and an interior surface. Additionally, said bottom member 240 further comprises front, back, bottom and two side walls, each wall of said bottom member 240 having both an interior surface and an exterior surface. In further embodiments of the present invention, at least one test strip 700 is located in a space defined by the interior surface of the top member 230 and the interior surfaces of the bottom member 240 (see FIG. 7).

Referring to FIGS. 1-9 and 12, certain embodiments of the present invention further comprise at least one results aperture 232 for viewing the results of the diagnostic test. Preferably, the results aperture 232 is located in the top member 230 above the results portion of the at least one test strip 700. The results aperture 232 optionally has indicia, said capable of indicating to the user the location of test results on the test strip 700 and what analyte is being tested for. Optionally, there may be two, three, four or five or more results apertures 232, located side-by-side on the top member 230, to enable the use of five or more individual test strips 700. FIGS. 1-9 and 12 show one embodiment of the present invention, with two results apertures 232 for viewing test results. In the case where a body 110 has multiple test strips 700 including indicia, the test strips 700 can include reagents and binding members for different analytes, allowing the user to assay for the presence of more than one analyte simultaneously. Results apertures 232 having indicia printed directly thereby, or having indicia in the form of attached “sticker labels”, can be assembled into test devices in any of a large number of configurations and combinations, such that a given test device can have a particular subset of test strips specific for the detection of a particular subset of analytes, without changing the design of the body 110.

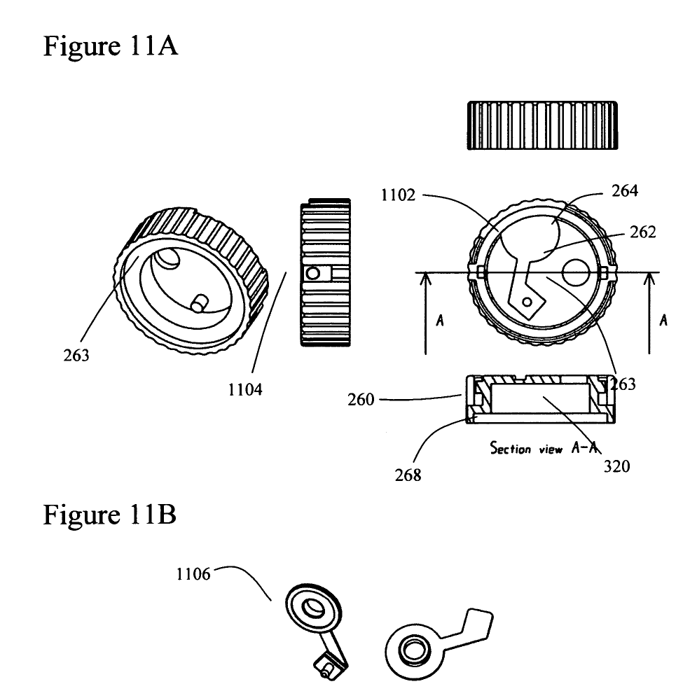

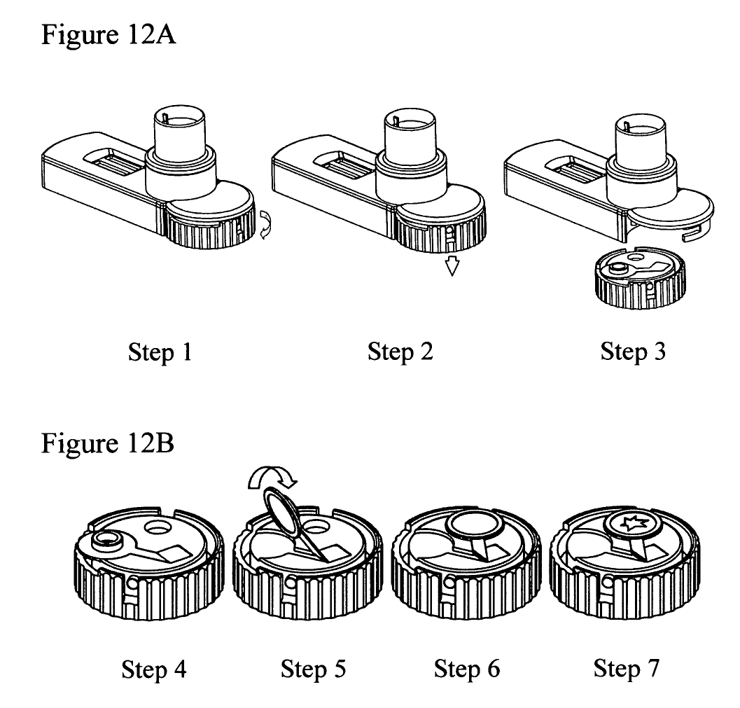

FIGS. 11 and 12 illustrate various embodiments of the sample reservoir 260. FIG. 1I shows the sample reservoir 260 as being generally disk shaped. However, other hollow shapes or vessels would be suitable. The sample reservoir 260 is constructed so as to be movably attached to the reservoir attachment means 236 of the body 110 top member 230. The sample reservoir 260 further comprises a top 262, an attachment slot 264 a bottom plate 268. Reservoir rotation groove 264 and reservoir pin 1104 guide the rotation of the reservoir 260 about the reservoir attachment means 236. The reservoir top 262 further comprises a reservoir aperture 263 in fluid communication with the sample divider 310 via the sample divider first aperture 311. The reservoir aperture 263 further comprises an O-ring 239 that prevents leakage from the reservoir aperture 263. A portion of the divided sample 710 flows from the sample divider 310, through the reservoir aperture 263 and into the lumen of the reservoir 320.

In the closed position, the sample cannot flow back out of the reservoir 260, through the reservoir aperture 263. When the reservoir is in the closed position, the sample can be stored under appropriate conditions, such as refrigeration. Alternatively, the device with a closed reservoir containing saved sample can be shipped to a confirmation laboratory, to have the test results confirmed. In the closed position, the confirmation laboratory technician can remove an aliquot of the stored sample by breaking the reservoir aperture seal 234.

Referring now to FIGS. 11 and 12, in certain embodiments of the present invention, the reservoir 260 is removable and has a reservoir aperture cap 1106. In some embodiments, the reservoir aperture cap 1106 is recessed in a cavity on the top 262 of the reservoir 260, so that the cap 1106 does not interfere with the movement of the reservoir about the reservoir attachment means 236. As shown in FIG. 12A, steps 1-3, the reservoir 260 is disengaged from the reservoir attachment means 236 by rotating the reservoir clockwise, from the open position to the remove position (Step 2), and then moving the reservoir 260 away from the body 110 of the test device (Step 3). FIG. 12B, steps 4-7 illustrate how the removed reservoir 260 can be optionally sealed in this embodiment of the present invention. Step 4 shows the reservoir 260 removed from the reservoir attachment means 236. The cap 1106 is preferably manufactured of flexible plastic. However, other suitable materials know in the art, such as tape or wax, may be used. The cap 1106 is easily flipped up (Step 5) and over and pressed into the reservoir aperture 263 (Step 6). The reservoir 260 is now sealed. Sample can be removed from the sealed reservoir by either puncturing or removing the cap 1109 (Step 7).

In certain embodiments of the present invention, the body 110 of the test device can be made of suitable material such as, but not limited to, glass, ceramics, metals, plastics, polymers, or copolymers, or any combination thereof but preferably comprises a plastic, polymer or copolymer such as those that are resistant to breakage, such as polypropylene, polyallomer, polycarbonate or cycloolefins or cycloolefin copolymers. A body 110 can be made by appropriate manufacturing methods, such as, but not limited to, injection molding, blow molding, machining or press molding. The components of the present invention, to be described herein, can be assembled by any means available in the art, such as glue, sonic welding, micro-welding, heating, compression joining, snapping pinching and the like.

As described supra, the absorbent member 255 of the sample applicator 120 further comprises an absorbent member 255 that is generally made of medical grade sponge or foam material commonly used in the art; however, many other materials are available for use as an absorbent member 255, such as cotton or paper. In another embodiment of the present invention, the absorbent member 255 is optionally treated with a solution, to promote salivation in the subject. These solutions contain, for example, buffer and optionally color or flavoring. An example solution is a weak citric acid buffer. The absorbent members are soaked in the solution, removed, and then dried. The dried, treated absorbent member 255 may then be attached to the attachment means 252 of the handle 250.

The test strip 700 housed within the body 110 of the test device of the present invention can be of any test element known in the art and can comprises a lateral flow detection device such as a test strip, such as an immunological test strip. The body 110 of the present invention can house one or more test strips 700. The one or more test strips 700 can be of any shape and dimensions, but is a rectangular test strip 700 is most commonly used.

The test strip 700 of a test device of the present invention may comprise, at least in part, any bibulous or non-bibulous material, such as nylon, paper, glass fiber, dacron, polyester, nitrocellulose, polyethylene, olefin, or other thermoplastic materials such as polyvinyl chloride, polyvinyl acetate, copolymers of vinyl acetate and vinyl chloride, polyamide, polycarbonate, polystyrene, etc. In one embodiment, at least one test strip 700 material is nitrocellulose having a pore size of at least about 1 micron, more preferably of greater than about 5 microns, or about 8-12 microns. Very suitable nitrocellulose sheets having a nominal pore size of up to approximately 12 microns, are available commercially from, for example, Schleicher and Schuell GmbH.

A test strip 700 can include one or more materials. If a test strip 700 comprises more than one material, the one or more materials are preferably in fluid communication. One material of a test strip may be overlaid on another material of the test strip, such as for example, filter paper overlaid on nitrocellulose. Alternatively or in addition, a test strip may include a region comprising one or more materials followed by a region comprising one or more different materials. In this case, the regions are in fluid communication and may or may not partially overlap one another.

The material or materials of the test strip 700 can be bound to a support or solid surface such as found, for example, in thin-layer chromatography and may have an absorbent pad either as an integral part or in liquid contact. For example, a test strip 700 may comprise nitrocellulose sheet “backed”, for example with a supporting sheet, such as a plastic sheet, to increase its handling strength. This can be manufactured by forming a thin layer of nitrocellulose on a sheet of backing material. The actual pore size of the nitrocellulose when backed in this manner will tend to be lower than that of the corresponding un-backed material. Alternatively, a pre-formed sheet of nitrocellulose and/or one or more other bibulous or non-bibulous materials can be attached to at least one supporting sheet, such as a sheet made of polymers (see, U.S. Pat. No. 5,656,503 to May et al., issued Aug. 12, 1997). The supporting sheet can be transparent, translucent or opaque. In the embodiment of the present invention where the support sheet is transparent, the supporting sheet is preferably moisture impervious but can be moisture resistant or moisture pervious. The test strip 700 can be assembled in a body 110 of the present invention such that the support sheet is optionally on the side of the test strip 700 that can be viewed from the results aperture 232 of the top member 230 of the body 110. In another embodiment of the present invention the test strip 700 can be viewed through a window comprised of a transparent material such as glass, plastic, or mylar, but preferably break resistant.

In the following discussion strips of test strip material will be described by way of illustration and not limitation.

Generally, test strips 700 of a test device of the present invention include a sample application zone and a test results determination zone. The test results determination zone can include either or both of one of more analyte detection zones and one or more control zones. Optionally, a test strip can include a reagent zone.

One or more specific binding members in the test results determination zone of the test strip can be impregnated throughout the thickness of the bibulous or non-bibulous material in the test results determination zone (for example, specific binding members for one or more analytes can be impregnated throughout the thickness of the test strip material in one or more analyte detection zones, and specific binding members for one or more control analytes can be impregnated throughout the thickness of the test strip material in one or more control zones, but that need not be the case). Such impregnation can enhance the extent to which the immobilized reagent can capture an analyte present in the migrating sample. Alternatively, reagents, including specific binding members and components of signal producing systems may be applied to the surface of the bibulous or non-bibulous material. Impregnation of specific binding members into test strip materials or application of specific binding members onto test strip materials may be done manually or by machine.

Nitrocellulose has the advantage that a specific binding member in the test results determination zone can be immobilized without prior chemical treatment. If the porous solid phase material comprises paper, for example, the immobilization of the antibody in the test results determination zone can be performed by chemical coupling using, for example, CNBr, carbonyldiimidazole, or tresyl chloride.

Following the application of a specific binding member to the test results determination zone, the remainder of the porous solid phase material should be treated to block any remaining binding sites elsewhere. Blocking can be achieved by treatment with protein (for example bovine serum albumin or milk protein), or with polyvinyl alcohol or ethanolamine, or any combination of these agents. A labeled reagent for the reagent zone can then be dispensed onto the dry carrier and will become mobile in the carrier when in the moist state. Between each of these various process steps (sensitization, application of unlabeled reagent, blocking and application of labeled reagent); the porous solid phase material should be dried.

To assist the free mobility of the labeled reagent when the test strip is moistened with the sample, the labeled reagent can be applied to the bibulous or non-bibulous material as a surface layer, rather than being impregnated in the thickness of the bibulous material.

The reagents can be applied to the carrier material in a variety of ways. Various “printing” techniques have previously been proposed for application of liquid reagents to carriers, for example micro-syringes, pens using metered pumps, direct printing and ink-jet printing, and any of these techniques can be used in the present context. To facilitate manufacture, the carrier (for example sheet) can be treated with the reagents and then subdivided into smaller portions (for example small narrow strips each embodying the required reagent-containing zones) to provide a plurality of identical carrier units.

In embodiments where the analyte is detected by a signal producing system, such as by one or more enzymes that specifically react with the analyte, one or more components of the signal producing system can be bound to the analyte detection zone of the test strip material in the same manner as specific binding members are bound to the test strip material, as described above. Alternatively or in addition, components of the signal producing system that are included in the sample application zone, the reagent zone, or the analyte detection zone of the test strip, or that are included throughout the test strip, may be impregnated into one or more materials of the test strip. This can be achieved either by surface application of solutions of such components or by immersion of the one or more test strip materials into solutions of such components. Following one or more applications or one or more immersions, the test strip material is dried. Alternatively or in addition, components of the signal producing system that are included in the sample application zone, the reagent zone, or the analyte detection zone of the test strip, or that are included throughout the test strip, may be applied to the surface of one or more test strip materials of the test strip as was described for labeled reagents.

The sample application zone is an area of a test strip where a sample, such as a fluid sample, such as a biological fluid sample such as blood, serum, saliva, or urine, or a fluid derived from a biological sample, such as a throat or genital swab, is applied. The sample application zone can include a bibulous or non-bibulous material, such as filter paper, nitrocellulose, glass fibers, polyester or other appropriate materials. One or more materials of the sample application zone may perform a filtering function, such that large particles or cells are prevented from moving through the test strip. The sample application zone can be in direct or indirect fluid communication with the remainder of the test strip, including the test results determination zone. The direct or indirect fluid communication can be, for example, end-to-end communication, overlap communication, or overlap or end-to-end communication that involves another element, such as a fluid communication structure such as filter paper.

The sample application zone can also include compounds or molecules that may be necessary or desirable for optimal performance of the test, for example, buffers, stabilizers, surfactants, salts, reducing agents, or enzymes.

The test strip can also include a reagent zone where reagents useful in the detection of an analyte can be provided immobilized (covalent or non-covalent immobilization) or not immobilized, particularly when in a fluid state. The reagent zone can be on a reagent pad, a separate segment of bibulous or non-bibulous material included on the test strip, or it can be a region of a bibulous or non-bibulous material of a test strip that also includes other zones, such as an analyte detection zone. In one embodiment of the invention, the reagent zone can include a labeled specific binding member, such as antibodies or active fragments thereof attached or linked to a label. Such labeled specific binding members can be made using methods known in the art. The specific binding members can bind an analyte and/or can bind a control compound.

In one certain example involving detection of HIV, the reagent zone includes two populations of colored beads. One population of colored beads is attached to an anti-rabbit IgG antibody or active fragment thereof and the other population of colored beads is attached to an anti-HIV beta chain antibody or active fragment thereof. The labeled anti-rabbit IgG antibody or antibody fragment is used for visual detection of a signal in the control zone of the test strip. A color signal in the control zone indicated that the sample has passed through the detection zone. The labeled anti-HIV beta chain antibody or fragment thereof provides a visual signal in the detection zone indicating the presence of HIV in the sample.

Other certain embodiments are having anti-(drug of abuse) antibodies or active fragments thereof bound to a population of colored beads. More than one population of beads can be used as in the forgoing example to provide a visual signal in the detection zone and a second visual signal in the control zone. The two populations of beads can be the same or different colors or be provided as a mixture of colors. Alternatively or in addition, different populations of beads bound to different antibodies or antibody fragments can be used to indicate the presence of more than one analyte in a sample by producing one or more visual signals in one or more detection zones.

In another embodiment of the invention, the reagent zone includes the analyte or an analyte analog bound to a population of colored beads. In this case, the analyte in the sample competes with the labeled analyte or analyte analog provided in the reagent zone for binding to a specific binding member in the test results determination zone. A reduced visual signal in comparison with a control sample lacking analyte indicates the presence of analyte in the sample. More than one population of beads can be used as in the forgoing examples to provide a visual signal in the analyte detection zone and a second visual signal in the control zone. Alternatively or in addition, different populations of beads bound to different analytes or analyte analogs can be used to indicate the presence of more than one analyte in a sample by producing one or more visual signals in one or more detection zones.

Certain labels are beads such as metal particles, such as gold, or polymeric beads, such as colored beads, or particles of carbon black. Other labels include, for example, enzymes, chromophores or fluorophores such as they are known in the art, particularly in immunoassays, or later developed. The populations of beads are provided in powdered form on the reagent zone, which can include a bibulous material, such as filter paper, glass fibers, nylon, or nitrocellulose. These reagents are reversibly bound to the reagent zone because they can be mobilized when placed in contact with a fluid, such as a fluid sample passing along a test strip.

In another embodiment of the invention, the reagent zone can include components of a signal producing system, for example, catalysts, such as enzymes, cofactors, electron donors or acceptors, and/or indicator compounds.

The reagent zone can also include compounds or molecules that may be necessary or desirable for optimal performance of the test, for example, buffers, stabilizers, surfactants, salts, reducing agents, or enzymes.

The test results determination zone includes immobilized or not immobilized reagents that can detect the presence of the analyte being tested for, such as but not limited to, drugs of abuse, hormones, metabolites, and antibodies. Such reagents are preferably in a dry state and can be covalently immobilized, non-covalently immobilized, or not immobilized in a fluid state. The test result determination zone can include either or both of one or more analyte detection zones and one or more control zones.

Depending on the particular format and analyte being tested for, a variety of reagents can be provided at the test results determination zone. For example, the test results determination zone can include specific binding members such as antibodies, enzymes, enzymatic substrates, coenzymes, enhancers, second enzymes, activators, cofactors, inhibitors, scavengers, metal ions, and the like. One or more of the reagents provided at the test results determination zone can be bound to the test strip material. Test strips including such reagents are known in the art and can be adapted to the test device of the present invention.

In a certain embodiment of the present invention, the one or more analyte detection zones of the test results determination zone include one or more immobilized (covalently or non-covalently immobilized) specific binding members that bind with one or more analytes of interest, such as one or more drugs, hormones, antibodies, metabolites, or infectious agents, when the analytes are also bound by specific binding members bound to a label as are provided in the reagent zone. Thus, in embodiments where the reagent zone contains one or more specific binding members for the analyte, the specific binding members of the reagent zone and analyte detection zone should bind with different epitopes on the analyte being tested for. For example, when a labeled specific binding member in the reagent zone binds with the beta-chain of HIV, then the immobilized specific binding member in the analyte detection zone should bind with another area of HIV, such as the alpha-chain of HIV. Thus, when HIV is present in the sample, the HIV will bind the labeled anti-beta HIV which carried along to the test result determination zone at the analyte detection zone which binds with the immbolized anti-alpha HIV to provide a visual readout at that locus.

The analyte detection zone can include substrates which change in an optical property (such as color, chemiluminescence or fluorescence) when an analyte is present. Such substrates are known in the art, such as, but not limited to, 1,2-phenylenediamine, 5-aminosalicylic acid, 3,3′,5,5′tetra methyl benzidine, or tolidine for peroxidase; 5-bromo-4-chloror-3-indolyl phosphate/nitroblue tetrazolium for alkaline phosphatase and 5-bromo-4-chloro-3-indolyl-beta-D-galactopyranoside, o-nitrophenyl-beta-D-galactopyranoside, napthol-AS-BI-beta-D-galactopyranoside, and 4-methyl-umbelliferyl-beta-D-galactopyranoside for beta galactosidase.

In embodiments where an analyte is detected by a signal producing system, one or more components of the signal producing system, such as enzymes, substrates, and/or indicators, can be provided in the analyte detection zone. Alternatively, the components of the signal producing system can be provided elsewhere in the test strip and can migrate to the analyte detection zone.

Optionally, the test results determination zone can include a control zone. The control zone can be upstream from, downstream from, or integral with the analyte detection zone of the test result determination zone. In the latter case, when analyte and control give a positive reaction, the control zone and analyte detection zone can form an indicia, such as a “+” sign for a positive reaction and a “−” sign for a negative reaction based on the particular format of the assay.

The control zone provides a result that indicates that the test on the test strip has performed correctly. In one certain embodiment of the present invention, the reagent zone includes a specific binding member that binds with a known analyte different from the analyte being tested for. For example, a rabbit-IgG may be provided in the reagent zone. The control zone can include immobilized (covalently or non-covalently) anti-rabbit-IgG antibody. In operation, when the labeled rabbit-IgG in the reagent zone is carried to the test result determination zone and the control zone therein, the labeled rabbit-IgG will bind with the immobilized an anti-rabbit-IgG and form a detectable signal.

The control zone can include substrates which change in an optical property (such as color, chemiluminescence or fluorescence) when a control substance is present.

In one embodiment of the present invention, a test strip can include an adulteration control zone that is capable of detecting an adulteration analyte or an adulteration indicator. Such an adulteration control zone can be in addition to or in place of a control zone or a test results determination zone as described herein. In one embodiment of the present invention, the test strip can include an adulteration control zone and a control zone and can optionally detect another analyte such as a drug. In the case where a test strip includes an adulteration control zone and a control zone, but does not detect another analyte, the test strip can be used as a separate control strip, which can be provided in a separate results aperture 232 of the body 110 of the present invention.

The adulteration control zone can detect an analyte using any appropriate method, such as specific binding methods or using chemical detection methods. These types of detection methods are known in the art and are described herein. For example, specific binding methods such as antibody detection methods are described herein. Also, methods to detect an analyte using signal detection methods using chemical or enzymatic methods are also described herein.

Adulteration control zones preferably detect the presence or amount of an analyte that reflects sample adulteration, such as adulteration by dilution, such as substitution or addition of materials from another species, subject or non-human source to a sample or by the addition of an altering agent. Depending on the monitoring of sample acquisition, sample chain of custody and sample preparation, the need for adulteration controls can be different. For example, blood, serum or plasma samples tend to be more difficult for a subject from which such a sample is taken from to adulterate because such samples tend to be drawn by a phlebotomist or other health-care professional and the chain of custody for such samples tend to be relatively rigorous. On the other hand, samples of urine or other bodily fluids tend to be less stringently controlled, but that need not be the case. The choice of adulteration controls can be chosen based on the particular circumstances for sample collection and chain of title as appropriate.

An appropriate adulteration control for different sample types, such as serum, blood, saliva or urine, can be chosen by the skilled artisan. For example, certain analytes for blood or blood derived sample dilution include but are not limited to hematocrit, protein concentration; hemoglobin (particularly for red blood cell lysis) and analytes for urine or urine derived sample dilution include but are not limited to creatine. Certain analytes for blood or blood derived sample species include but are not limited to cell-surface antigens or immunoglobulins of any class or subclass, such as IgG, IgM, IgA, IgE or IgD and analytes for urine or urine derived sample species include but are not limited to cell-surface antigens or immunoglobulins of any class or subclass, such as IgG, IgM, IgA, IgE or IgD and analytes for urine or urine derived sample subject include but are not limited to hormones such as testosterone, estrogen or cell surface antigens. Certain analytes for adulterants for blood or blood derived samples include but are not limited to pH, hemoglobin and nitrites. Certain analytes for adulterants include, but are not limited to pH and the adulterants or their derivatives, such as break down products, or derivatives in the sample based on the action of the adulterant, such as the presence or absence of analytes normally present in the sample in the absence of an adulterant or break down products or altered analytes based on the action of an adulterant. Certain adulterants include, but are not limited to hypochlorite (bleach), chlorine, gluteraldehyde, soap, detergent, Drano™, Visine™, Golden Seal Tea™, citrus products such as juice such as lemon or lime juice, nitrate, Urine Luck™ and pyridinium chlorochromate.

Adulteration control zones can be made using methods known in the art and described herein, such as for making a test results determination zone to detect an analyte. The adulteration control zone can be thought of as a test results determination zone for an adulteration analyte and thus the reagent zone can include appropriate reagents for performing an assay for an adulteration analyte. For example, a test strip can include detectably labeled rabbit anti-human IgG and the adulteration control zone can include immobilized goat anti-human IgG antibodies. Thus, in operation of the test strip, the sample adulteration control zone having the detectable label bound thereto would indicate that the sample contains human IgG and thus is presumptively of human origin. If, for example, a supposedly human serum sample was used as a sample in such a test strip, the lack of a detectable label in the sample adulteration control zone would indicate that the sample was not of human origin and thus would not be a valid test. In those circumstances, the test results would indicate that the sample was adulterated, such as providing a serum sample from another species or by altering the sample such that human IgG was degraded or otherwise not present. Adulteration tests can be quantitative or semi-quantitative such that dilution of a sample of human origin would result in a readout having less detectable label than a standard range for undiluted samples. Adulteration tests can be used to detect one or more adulterants in one or more test strips. For example, a single adulteration test strip can detect one or more adulterants.

In one certain embodiment of the present invention, the test strip can include a results determination zone that includes a control zone and an analyte detection zone, and a sample adulteration control zone. In another embodiment of the present invention, a test strip can include a results determination zone that optionally includes a control zone, and optionally an adulteration control zone. A second test strip can include an adulteration control zone and optionally a control zone. Preferably, this second test strip includes both an adulteration control zone and a control zone, but that need not be the case. In the instance where one or more first test strips can be used to detect an analyte other than an adulteration analyte and one or more second test strips can be used to detect an adulteration analyte, the test strips can be provided in a single test body of the present invention, such as a multi-channel test body.

The various zones of a test strip, including a sample application zone, one or more reagent zones, and one or more test result determination zones, including one or more analyte detection zones and optionally including one or more control zones and one or more adulteration zones, can be on a single strip of material, such as filter paper or nitrocellulose, or can be provided on separate pieces of material. The different zones can be made of the same or different material or a combination of materials, but preferably are selected from bibulous materials, such as filter paper, fiberglass mesh and nitrocellulose. The sample application zone preferably includes glass fibers, polyester or filter paper, the one or more reagent zones preferably include glass fibers, polyester or filter paper and the test results determination zone, including one or more analyte detection zones and optionally including one or more control zones, preferably include nitrocellulose.

Optionally, a fluid absorbing zone is included. The fluid absorbing zone preferably includes absorbent paper and is used to absorb fluid in a sample to drive fluid from the sample application zone through the reagent zone and the detection zone.

Preferably, the zones are arranged as follows: sample application zone, one or more reagent zones, one or more test results determination zones, one or more control zones, one or more adulteration zones, and fluid absorbing zone. If the test results determination zone includes a control zone, preferably it follows the analyte detection zone of the test result determination zone. All of these zones, or combinations thereof, can be provided in a single strip of a single material. Alternatively, the zones are made of different materials and are linked together in fluid communication. For example, the different zones can be in direct or indirect fluid communication. In this instance, the different zones can be jointed end-to-end to be in fluid communication, overlapped to be in fluid communication, or be communicated by another member, such a joining material, which is preferably bibulous such as filter paper, fiberglass or nitrocellulose. In using a joining material, a joining material may communicate fluid from end-to-end joined zones or materials including such zones, end-to-end joined zones or materials including such zones that are not in fluid communication, or join zones or materials that include such zones that are overlapped (such as but not limited to from top to bottom) but not in fluid communication.

When and if a test strip includes an adulteration control zone, the adulteration control zone can be placed before or after the results determination zone. When a control zone is present in the results determination zone on such a test strip, then the adulteration control zone is preferably before the control zone, but that need not be the case. In the embodiment of the present invention where a test strip is a control test strip for the determination of an adulteration analyte and/or a control, then the adulteration control zone can be placed before or after the control zone, but is preferably before the control zone.

In a certain embodiment of the test device of the present invention the sample application well 210 with sample is engaged with the test strips such that the distal, or outlet end of the sample application well 210 is inserted or otherwise affixed to or within an aperture of the top member 230. The contents of the sample application well 210 can be released into the aperture of the top member 230 and comes into fluid contact with at least one test element, preferably the sample application zone of a test strip. The sample flows along the test strip by wicking action and can optionally come into fluid contact with specific one (or more) analyte, antibody or labeled member for an analyte, or a combination thereof, which can be freely mobile within the bibulous material when in the moist state. In a certain embodiment of the present invention the test contents of the sample and optional elements of the test strip come into fluid contact with a detection zone of the test strip that can indicate the presence or absence for a specific analyte in the sample.

Methods of Use

The present invention contemplates several alternative methods of use of the device described supra. In one embodiment, the applicator 120 is given to a subject. The subject then sucks or chews the absorbent member 255, until the absorbent member has become soft and pliable. The technician operating the device removes the applicator 120 from the subject's mouth and inserts the applicator 120 into the sample application well 210. Next, the technician manually pushes the applicator 120 down into the application well 210 and then turns the applicator to lock the flanges 600 on the applicator handle 251 under the ribs 430 within the application well 210. When the technician pushed the applicator 120 down, sample, for example saliva, is expressed from the absorbent member 255 by the expression means 300. The expressed sample is divided into two parts. The first part of the sample enters the sample reservoir 260 via a first sample divider aperture 311. The second portion of the sample flows onto the test strip 700 via a second sample divider aperture 312. The technician waits until the controls indicate that sufficient time has passed to read the test results. The technician reads the test results by observing the results through the results aperture 232. After reading the test results, the technician closes the reservoir, by rotating the reservoir to the closed position. The device could now be stored, for future use of the sample. Alternatively, the device could be shipped to an off-site location, where confirmation testing could be performed on the remaining sample contained within the reservoir.

In another embodiment of the present invention, the technician could dissolve or suspend a sample, such as feces, in a buffer. The sample could then be absorbed by the sample applicator and transferred to the test device. Alternatively, the dissolved or suspended sample could be poured into the sample application well.

In yet another embodiment of the present invention, at the conclusion of the test, the reservoir would be removed from the test device and sealed with an attached cal 1106. The sealed reservoir could be stored or shipped, while the remaining portion of the device could be disposed of by appropriate means.

Kits

The present invention contemplates a variety of kits. For example, a kit could comprise a single test with instructions included in the package. In a clinical setting, for example, it may be more desirable to package several individually wrapped absorbent applicators 120, and equal number of individually wrapped bodies 110, and one set of instructions. In certain embodiments, a kit might include control solutions, for testing a representative number of devices from a single lot of devices. In additional embodiments, a kit might contain additional reagents for pre-treating various kinds of samples, such a blood, serum, and feces.

What is claimed:

1. A test device for detecting an analyte suspected of being present in a liquid sample, comprising:
a. an absorbent sample applicator, for collecting the sample from a subject in need of testing for an analyte in a sample of a subject;
b. a casing;
c. a sample application well connected to said casing;
d. a sample divider for dividing the sample into a first portion to be tested and a second portion to be stored or used for optional confirmation testing; and
e. a sample reservoir in fluid communication with said sample divider, for collecting said second portion of the sample for storage and optional confirmation testing.

2. The test device of claim 1, further comprising at least one test strip encased within said casing and in fluid communication with said sample divider, for enabling diagnostic testing of said first portion of the sample.

3. The test device of claim 1, wherein said sample applicator further comprises an absorbent member and a handle.

4. The test device of claim 3, wherein said absorbent member further comprises a sponge.

5. The test device of claim 3, wherein said absorbent member further comprises a foam.

6. The test device of claim 3, wherein said absorbent member is treated with a solution that stimulates salivation in a subject from which the sample is collected.

7. The test device of claim 3, wherein said handle is substantially rigid and further comprises a textured grip for holding said sample applicator.

8. The test device of claim 2, wherein said casing further comprises a top portion and a bottom portion.

9. The test device of claim 8, wherein said top portion further comprises a reservoir attachment means.

10. The test device of claim 8, wherein said top portion further comprises a reservoir sealing means.

11. The test device of claim 10, wherein said reservoir sealing means is selected from the group consisting of foil, plastic, plastic coated foil, wax, and tape.

12. The test device of claim 8, said top portion further comprising a sample application well base.

13. The test device of claim 12, wherein said sample application well base further comprises said sample divider, said sample divider being in fluid communication with said reservoir and said at least one test strip.

14. The test device of claim 8, said top portion further comprising an aperture through which said as least one test strip can be observed, said aperture optionally having indicia to indicate the location of test results on said at least one test strip.

15. The test device of claim 8, said top portion further comprising an exterior surface and an interior surface and said bottom portion further comprises front, back, bottom and two side walls, each wall of said bottom portion having both an interior surface and an exterior surface.

16. The test device of claim 15, said at least one test strip being supported in a space defined by the interior surface of the top portion and the interior surfaces of the bottom portion.

17. The test device of claim 1, wherein said sample application well further comprises an expression means, for expressing the sample from said sample applicator upon said absorbent member being manually pressed into the expresser means.

18. The test device of claim 17, said expression means further comprising radial spokes against which the absorbent member is manually pressed and between which said sample flows to said sample divider.

19. The test device of claim 17, said expression means further comprising a wall against which said absorbent member is manually pressed and said wall having an aperture through which the sample flows to said sample divider.

20. The test device of claim 17, said expression means further comprising a wall against which said absorbent member is manually pressed and said wall having at least two apertures in fluid communication with said sample divider and through which said sample flows to said sample divider.

21. The test device of claim 1, said sample reservoir further comprising a reservoir aperture in fluid communication with said sample divider.

22. The test device of claim 21, said reservoir aperture further comprising an o-ring.

23. The test device of claim 1, said reservoir further comprising a reservoir rotation guide means.

24. The test device of claim 1, said reservoir being optionally removable.

25. The test device of claim 24, said reservoir further comprising a reservoir aperture cap.

26. The test device of claim 1, wherein the sample is a bodily fluid or derived from a tissue or a bodily fluid.

27. The test device of claim 1, wherein the sample is selected from the group consisting of blood, serum, plasma, urine, feces, spinal fluid, vaginal swabs, mucus, and tissue.

28. The test device of claim 1, wherein the analyte is an infectious agent or indicative of an infected state.

29. The test device of claim 1, wherein the analyte is an agent or substance indicative of a disease state.

30. The test device of claim 1, wherein said analyte of interest is selected from the group consisting of a drug, a drug of abuse, a hormone, a protein, a nucleic acid molecule, an etiological agent and a specific binding member.

31. The test device of claim 1, wherein the analyte is a drug of abuse.

32. The test device of claim 1, wherein the sample further comprises a biological sample.

33. The test device of claim 1, wherein the sample further comprises a viscous sample.

34. The test device of claim 1, wherein the sample further comprises oral fluid.

35. The test device of claim 1, wherein the sample further comprises saliva.

36. A method for detecting an analyte in a sample, comprising: contacting a test device of claim 1 with a sample and detecting the presence of said analyte in said sample.

37. A fluid specimen testing device comprising:
a. a sample collection swab including an absorbent member and a handle;
b. a sample expression and division means, by which a first portion of the sample is expressed from the swab and divided into a second portion and a third portion;
c. a testing means in direct fluid communication with the second portion of the sample, for testing the second portion of the sample for the presence of an analyte of interest; and
d. a storage means in direct fluid communication with the third portion of the sample; for storing the third portion of the sample for later use, such as confirmation testing.

38. A saliva testing and storage device comprising:
a. a fluid collection swab including a sponge portion adapted and suited to absorb an oral fluid specimen form the oral cavity of a test subject; and
b. a testing cassette, including:
c. an expresser means for expressing the specimen from the sponge portion upon the sponge portion being pressed into the expresser means;
d. a specimen dividing means that divides the expressed specimen into a first portion and a second portion;
e. a diagnostic testing means in direct fluid communication with the dividing mean that tests the first portion of the specimen;
f. a storage means in direct fluid communication and into which the second portion of the specimen is collected and stored.

39. A method of detecting an analyte of interest in a sample of a subject, comprising:
a. placing an absorbent collector in the subject's mouth and swabbing the subject's mouth until the absorbent collector is saturated with oral fluid or optionally saliva;
b. placing the sample saturated absorbent collector in a sample application well of a test device containing a test strip for diagnostic purposes;
c. manually pressing the saturated absorbent collector onto an expression means so that at least a portion of the liquid sample collected from the subject is expressed into the test device;
d. waiting a period of time sufficient for the expressed liquid sample to flow into the device and be divided by the device into at least two portions, a first portion that is in fluid communication with the test strip and a second portion that is in fluid communication with a sample storage reservoir; waiting a period of time sufficient for the first portion of the sample to be tested by the test strip for an analyte of interest, until the test is complete and then reading the results of the test; sealing the reservoir containing the second portion of the divided sample; and
e. storing the second portion of the divided sample.

40. The method of claim 39, said step of sealing the reservoir containing the second portion of the divided sample optionally further comprising the step of removing the reservoir from the test device.

41. The method of claim 39, wherein the analyte is an infectious agent or indicative of an infected state.

42. The method of claim 39, wherein the analyte is an agent or substance indicative of a disease state.

43. The method of claim 39, wherein the analyte is a drug of abuse.

44. The method of claim 39, wherein the sample further comprises a biological sample.

45. The method of claim 39, wherein the sample further comprises a viscous sample.

46. The method of claim 39, wherein the sample further comprises oral fluid.

47. The method of claim 39, wherein the sample further comprises saliva.

48. A kit, comprising: at least one test device of claim 1 packaged together with instructions for use of said test device.
